(19) United States
(12) Patent Application Publication
(10) Pub. No.: US 2016/0113398 A1
(43) Pub. Date: Apr. 28, 2016

(54) CABINET WITH LOCKABLE DRAWER STRUCTURE

(71) Applicant: TING YU CHANG, TAICHUNG CITY (TW)

(72) Inventor: TING YU CHANG, TAICHUNG CITY (TW)

(21) Appl. No.: 14/521,578

(22) Filed: Oct. 23, 2014

(51) Int. Cl. A47B 88/04; E05B 65/46

(52) U.S. Cl. CPC A47B 88/04; E05B 65/46

(57) ABSTRACT

A cabinet with lockable drawer structure includes a cabinet body and a drawer. The cabinet body has an interior space. Two slidable grooves and two baffling portions opposite thereto are respectively assembled in the interior space. The baffling portions are respectively located above the slidable grooves. Two rails are respectively secured at two lateral sides of the drawer. The drawer is slidably connected with the slidable grooves with the rails, so that the drawer is movable toward the interior space to a lock position. A plate body is pivoted on a rear side of the drawer and distant from the cabinet body. Two engaging portions are respectively, integrally and laterally extending from two lateral sides of the plate body. Accordingly, when the drawer is located at the lock position, the engaging portions are respectively engaged with the baffling portions so as to secure the drawer at the lock position.

### BACKGROUND OF THE INVENTION

1. Field of the Invention

The present invention relates to a lockable drawer structure, and more particularly to cabinet with lockable drawer structure having simple architecture and the drawers thereof can be prevented detaching from the cabinet body during its movement.

2. Description of the Prior Art

As shown in FIG. 6, a conventional cabinet with lockable drawer structure is illustrated and includes a cabinet body 61 and a drawer 64. Plural slidable grooves 62 and baffling portions 63 are respectively assembled in two lateral inner walls of the cabinet body 61. The drawer 64 has two rails 65 respectively secured at two sides thereof, thereby allowing the drawer 64 movable in a back-and-forth direction with respect to the interior space of the cabinet body 61. Two hooking members 66 are respectively pivoted at the two lateral sides of the drawer 64, and a hooking portion 661 and a forced portion 662 are respectively formed on two ends of each of the hooking members 66. The hooking portions 661 are respectively engaged with the baffling portions 63. A plate body 67 is secured on a rear side of the drawer 64 and distant from the cabinet body 61; a shaft 68 is transversely assembled below the plate body 67. Two ends of the shaft 68 are respectively connected to the forced portions 662 of the two hooking members 66 assembled to the two lateral sides of the drawer 64; moreover, the shaft 68 drives the hooking portions 661 of the hooking members 66 assembled to the two lateral sides of the drawer 64 to swing, so that the drawer 64 can be locked or unlocked quickly.

The conventional cabinet with lockable drawer structure uses two pivoting portions 69 so as to pivot the two hooking members 66 at the two lateral sides of the drawer 64, respectively; however, during assembling the pivoting portions 69 to the drawer 64, assembly errors between the hooking members 66 and the baffling portions 63 can be generated easily because the pivoting portions 69 are forced improperly or because the positions of the drawer 64 to be pivoted with the pivoting portions 69 are wrong. Furthermore, since the hooking members 66 are required to be connected with the shaft 68, thereby further increasing the assembly errors. Consequently, the hooking portions 661 cannot sufficiently engage with the baffling portions 63 after the hooking members 66 are assembled to the drawer 64.

Furthermore, it is realized that assembling the conventional cabinet with lockable drawer structure is complicated and man-hour consuming; and since the structural strengths of the hooking members 66 assembled to the two lateral sides of the drawer 64 are not quite strong enough, the hooking members 66 will start to sway after being used for a period, thereby attenuating the locking performance for the drawer 64.

The present invention is, therefore, arisen to obviate or at least mitigate the above mentioned disadvantages.

### SUMMARY OF THE INVENTION

An object of the present invention is to provide a cabinet with lockable drawer structure whose structure is simple and the assembly errors between the components thereof can be efficiently reduced.

To achieve the above and other objects, a cabinet with lockable drawer structure includes a cabinet body and a drawer. The cabinet body has an interior space. Two slidable grooves and two baffling portions opposite to the two slidable grooves are assembled in the interior space, respectively, and the two baffling portions are respectively located above the two slidable grooves. Two rails are respectively secured at two lateral sides of the drawer, and the drawer is slidably connected with the two slidable grooves in the interior space of the cabinet body with the two rails, so that the drawer is movable in a back-and-forth direction with respect to the interior space and is movable toward the interior space of the cabinet body to a lock position. A plate body is pivoted on a rear side of the drawer and distant from the cabinet body. Two engaging portions are respectively, integrally and laterally extending from right and left sides of the plate body and respectively located above the two rails. Accordingly, when the drawer is located at the lock position, the two engaging portions at the right and left sides of the plate body are respectively engaged with the two baffling portions in the interior space of the cabinet body.

Preferably, each of the two baffling portions has an engaging tooth protruded upwardly, so that an engaging groove is defined between each baffling portion and each corresponding engaging tooth; when the drawer is located at the lock position, the two engaging portions at the right and left sides of the plate body are respectively engaged with the engaging grooves of the two baffling portions; in addition, each of the baffling portions has an inclined guiding plane formed arcingly on one side of each corresponding engaging tooth thereof and distant from each corresponding engaging groove.

Preferably, the plate body is formed by bending a plate-shaped material into a structure with the cross section thereof being reversed U-shaped, so that the plate body defines a front lateral plane and a rear lateral plane; moreover, a pivoting structure is assembled on the rear sides of the drawer and distant from the cabinet body; the pivoting structure at least includes a positioning plate and a rotating plate connected together; the pivoting structure is connected with the rear side of the drawer via the positioning plate, and the rotating plate is provided to connect with a rear portion of the bottom of the plate body where the rear portion is near to the rear lateral plate, such that the plate body is pivotable with respect to the drawer via the pivoting structure.

Additionally, the pivoting structure further includes a torsion spring assembled therein, so that the plate body connected with the pivoting structure moves resiliently and automatically via the elastic force of the torsion spring.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an exploded view of the present invention;

FIG. 2 is a schematic view of the present invention in which the drawer is locked;

FIG. 3 is an operational view of the present invention showing the plate body is pushed upwardly by a user;

FIG. 4 is an operational view of the present invention showing the drawer is pulled from the interior space of the cabinet body by the user;

FIG. 5 is an operational view of the present invention showing the drawer is slid toward the lock position; and

FIG. 6 is an exploded view of a conventional cabinet with lockable drawer structure.

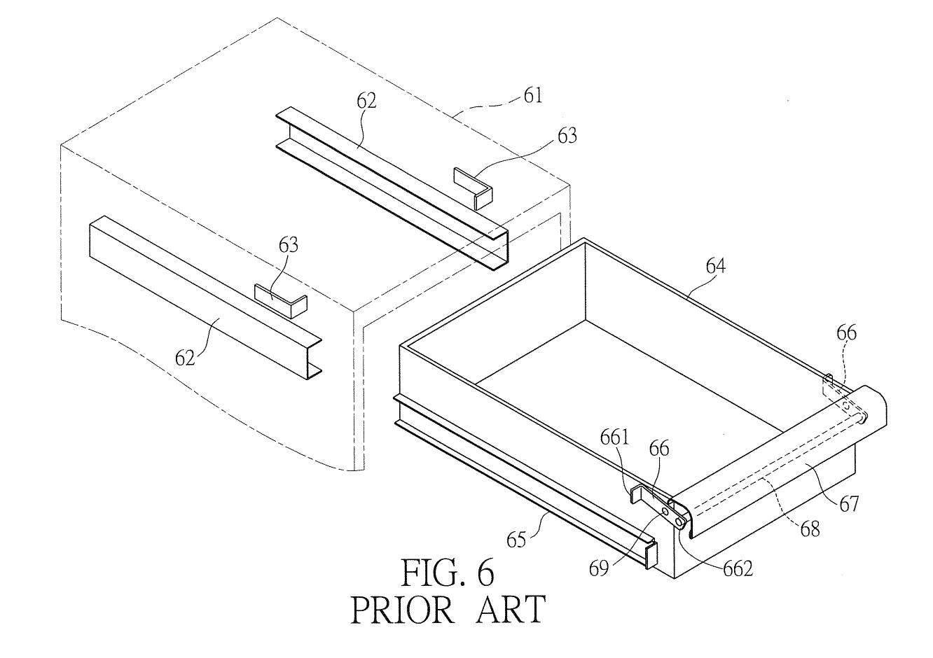

### DETAILED DESCRIPTION OF THE PREFERRED EMBODIMENTS

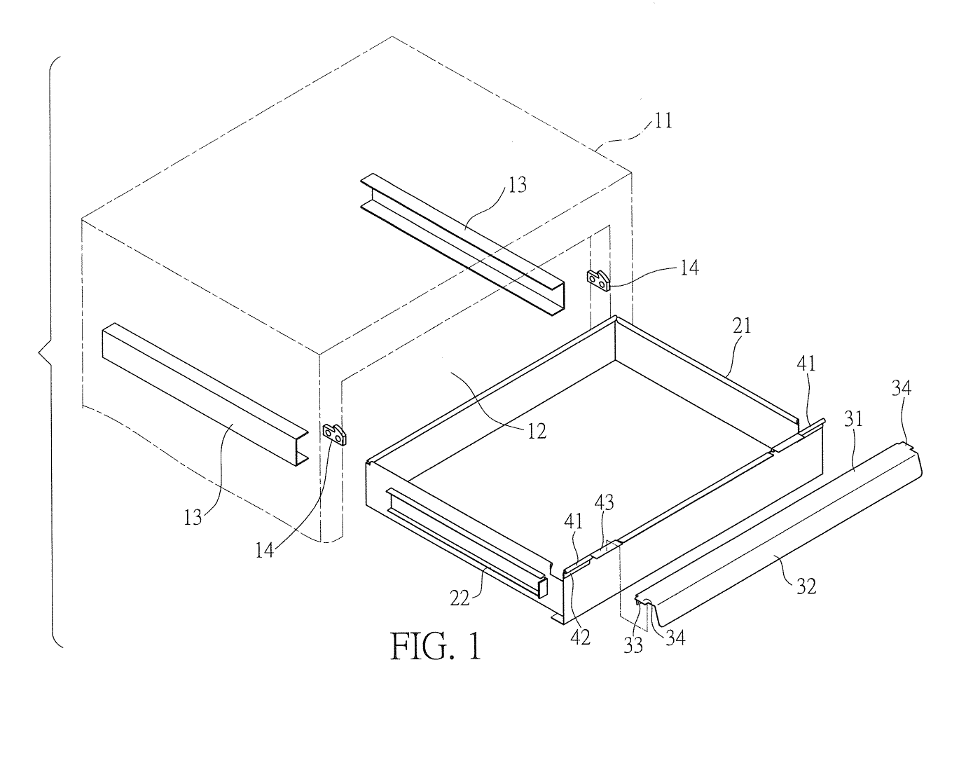

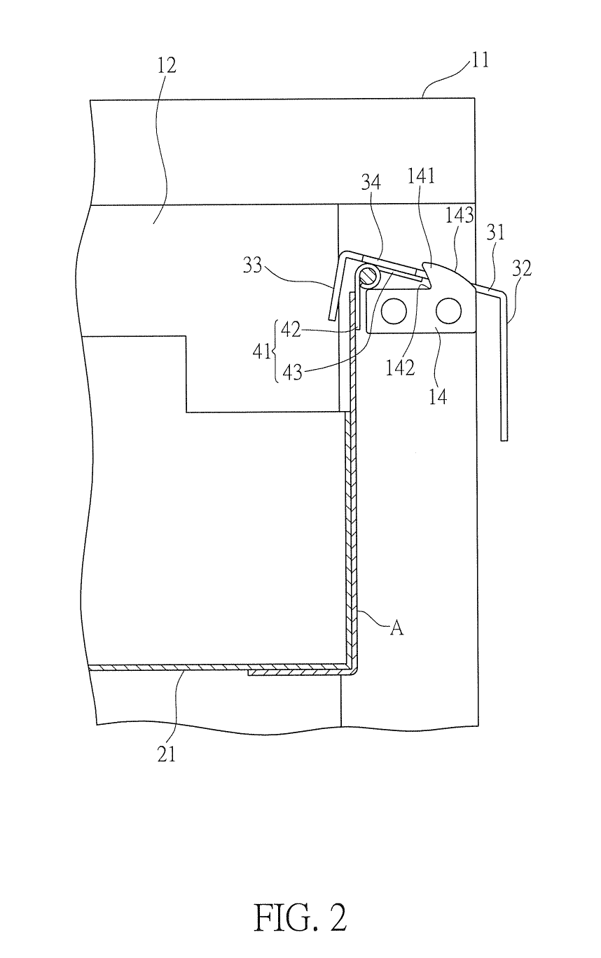

Referring to FIGS. 1-2, a cabinet with lockable drawer structure of the present invention is described as follows. The cabinet with lockable drawer structure includes, mainly, a cabinet body 11 and a drawer 21. The cabinet body 11 has an interior space 12. Two slidable grooves 13 and two baffling portions 14 are respectively assembled in the interior space 12, and the two baffling portions 14 are respectively opposite to the two slidable grooves 13. In this embodiment, the two baffling portions 14 are respectively located above the two slidable grooves 13, and each of the two baffling portions 14 has an engaging tooth 141 protruded upwardly, so that an engaging groove 142 is defined between each baffling portion 14 and each corresponding engaging tooth 141. Furthermore, each of the baffling portions 14 has an inclined guiding plane 143 formed arcingly on one side of each corresponding engaging tooth 141 thereof and distant from each corresponding engaging groove 142.

Two rails 22 are respectively secured at two lateral sides of the drawer 21, and the drawer 21 is slidably connected with the two slidable grooves 13 in the interior space 12 of the cabinet body 11 with the two rails 22, so that the drawer 21 is movable in a back-and-forth direction with respect to the interior space 12 and is movable toward the interior space 12 of the cabinet body 11 to a lock position A. A plate body 31 is pivoted on a rear side of the drawer 21 and distant from the cabinet body 11. The plate body 31 is formed by bending a plate-shaped material into a structure with the cross section of the plate body 31 being reversed U-shaped, so that the plate body 31 defines a front lateral plate 32 and a rear lateral plate 33. Two engaging portions 34 are respectively, integrally and laterally extending from right and left sides of the plate body 31, and the two engaging portions 34 are respectively located above the two rails 22. Based on this, when the drawer 21 is located at the lock position A, the two engaging portions 34 at the right and left sides of the plate body 31 are respectively engaged with the two baffling portions 14 in the interior space 12 of the cabinet body 11. In this embodiment, a pivoting structure 41 is assembled on the rear sides of the drawer 21 and distant from the cabinet body 11; the pivoting structure 41 at least includes a positioning plate 42 and a rotating plate 43 connected with each other. The pivoting structure 41 is connected with the rear side of the drawer 21 via the positioning plate 42, and the rotating plate 43 is provided to connect with a rear portion of the bottom of the plate body 31 where the rear portion is near to the rear lateral plate 33, so that the plate body 31 is pivotable with respect to the drawer 21 via the pivoting structure 41.

Please further refer to FIGS. 2-4, illustrating the operations of the cabinet with lockable drawer structure according to the present invention. As shown in FIG. 2, in a normal situation (when the present invention is placed in a right orientation), since the rotating plate 43 of the pivoting structure 41 is provided to connect with the rear portion of the bottom of the plate body 31, the plate body 31 is pivotally swung forwardly and downwardly because of its weight distribution. Therefore, when the drawer 21 is located at the lock position A, the engaging portions 34 of the plate body 31 are tilted and partially received in the engaging grooves 142 of the baffling portions 14, thereby the engaging portions 34 and the baffling portions 14 are engaged with each other and thus the drawer 21 cannot be pulled out of the interior space 12 of the cabinet body 11.

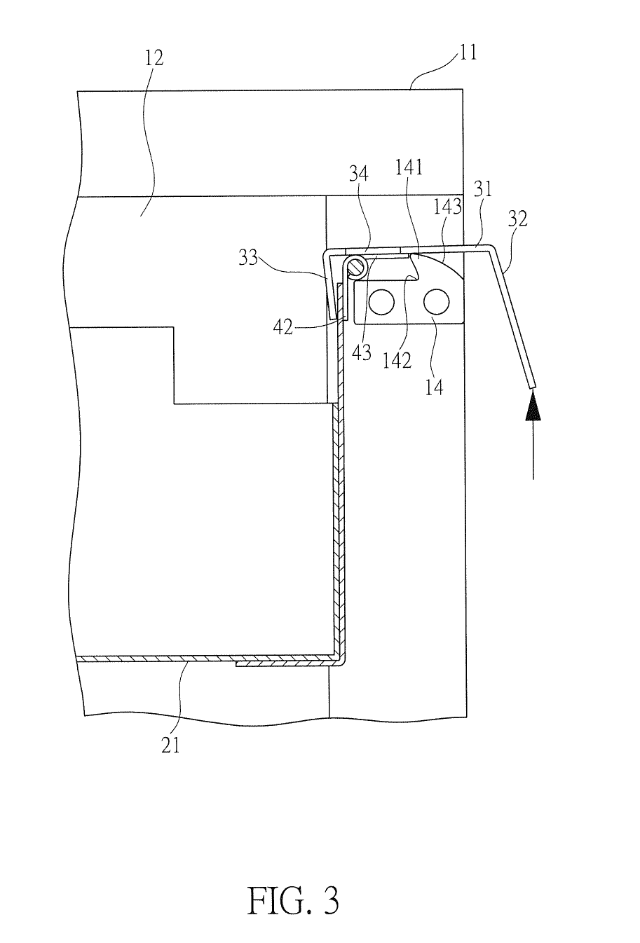

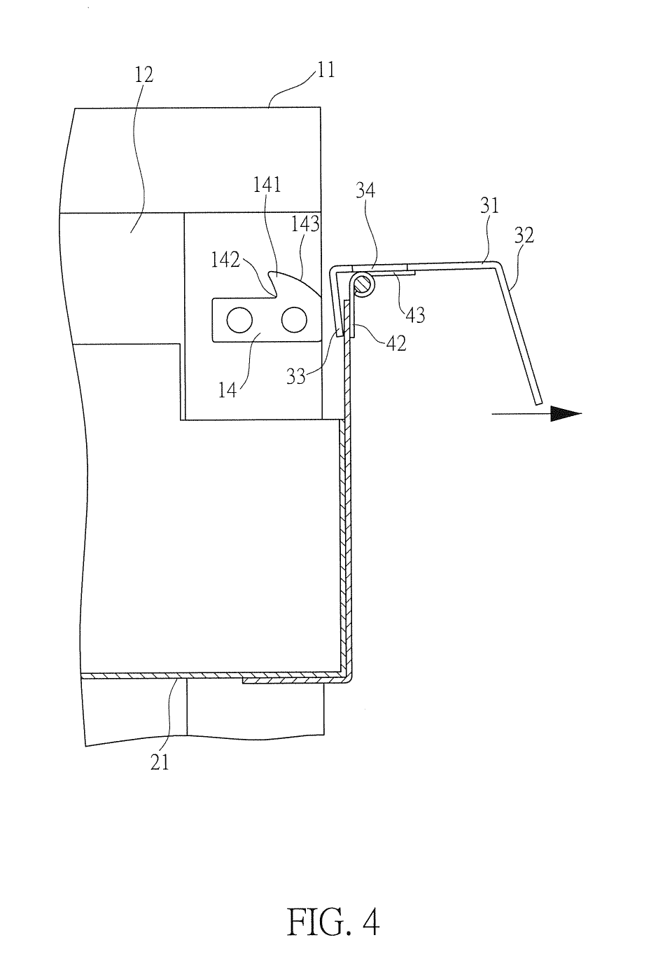

When a user tends to unlock the aforementioned locked drawer 21, as shown in FIG. 3, the user only need to push the front lateral plate 32 of the plate body 31 upwardly, and the engaging portions 34 at the right and left sides of the plate body 31 will tilt upwardly to detach from the engaging grooves 142 of the baffling portions 14, so that the engagement between the engaging portions 34 and the baffling portions 14 can be terminated, and the drawer 21 can be pulled out swimmingly and smoothly, as shown in FIG. 4.

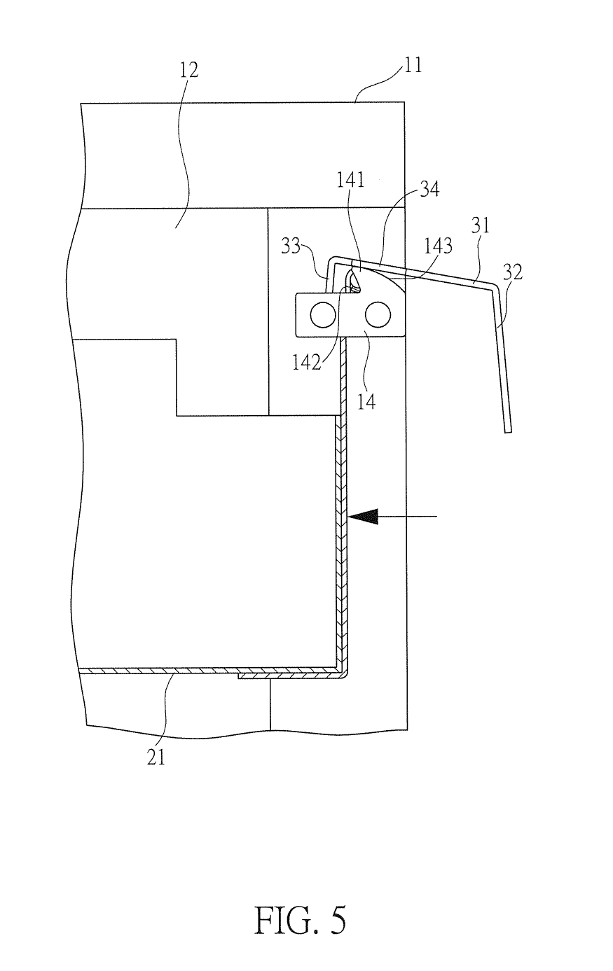

Furthermore, when the drawer 21 is tends to be slid back to the lock position A in the interior space 12 of the cabinet body 11, as shown in FIG. 5, since each of the baffling portions 14 has an inclined guiding plane 143 formed arcingly on one side of each corresponding engaging tooth 141 thereof and distant from each corresponding engaging groove 142, when the drawer 21 is slid toward the lock position A, the engaging portions 34 at the two lateral sides of the plate body 31 are respectively supported by the inclined guiding planes 143 of the engaging teeth 141 of the baffling portions 14 so as to pivotally swing along the inclined guiding plane 143 (that is, the engaging portions 34 are tilted upwardly because of the supporting of the inclined guiding planes 143); conversely, when the drawer 21 is slid back to the lock position A, the engaging portions 34 are automatically falling into the engaging grooves 142 of the baffling portions 14 because the aforementioned weight distribution, as the state illustrated in FIG. 2. Based on this, when the drawer 21 is slid back to the lock position A in the interior space 12 of the cabinet body 11, the drawer 21 can be automatically turned into the lock state without applying additional force to the plate body 31, thus the operation of the cabinet with lockable drawer structure being convenient for the user.

It is realized that, in some embodiments, the pivoting structure 41 further includes a torsion spring (not shown) assembled therein, so that the plate body 31 connected with the pivoting structure 41 are moved resiliently and automatically via the elastic force provided from the torsion spring.

Accordingly, the present invention has following advantages.

Firstly, with the engaging portions 34 integrally extending from the left and right sides of the plate body 31, the plate body 31 can directly engage with the baffling portions 14 in the cabinet body 11, thereby significantly improving the assembly error issue of the conventional.

Secondly, the structure of the present invention is simple, thus can be assembled easily and quickly, and the parallelism of the whole drawer structure can be ensured; furthermore, since the engaging portions 34 are respectively and integrally extending from the two lateral sides of the plate body 31, thereby having an excellent structural strength and would not start to sway after being used for a period, thus the locking performance for the drawer 21 is not attenuated.

Although particular embodiments of the invention have been described in detail for purposes of illustration, various modifications and enhancements may be made without departing from the spirit and scope of the invention. Accordingly, the invention is not to be limited except as by the appended claims.

1. A cabinet with lockable drawer structure, comprising:
a cabinet body, having an interior space, two slidable grooves and two baffling portions opposite to the two slidable grooves being respectively assembled in the interior space, and the two baffling portions being respectively located above the two slidable grooves; and
a drawer, two rails being respectively secured at two lateral sides of the drawer, the drawer being slidably connected with the two slidable grooves in the interior space of the cabinet body with the two rails, so that the drawer is movable in a back-and-forth direction with respect to the interior space and is movable toward the interior space of the cabinet body to a lock position, a plate body being pivoted on a rear side of the drawer and distant from the cabinet body, two engaging portions being respectively, integrally and laterally extending from right and left sides of the plate body, the two engaging portions being respectively located above the two rails, wherein when the drawer is located at the lock position, the two engaging portions at the right and left sides of the plate body are respectively engaged with the two baffling portions in the interior space of the cabinet body.

2. The cabinet with lockable drawer structure as claimed in claim 1, wherein each of the baffling portions has an engaging tooth protruded upwardly so that an engaging groove is defined between each baffling portion and each corresponding engaging tooth, when the drawer is located at the lock position, the two engaging portions at the right and left sides of the plate body are respectively engaged with the engaging grooves of the two baffling portions.

3. The cabinet with lockable drawer structure as claimed in claim 2, wherein each of the baffling portions has an inclined guiding plane formed arcingly on one side of each corresponding engaging tooth thereof and distant from each corresponding engaging groove.

4. The cabinet with lockable drawer structure as claimed in claim 1, wherein the plate body is formed by bending a plate-shaped material into a structure with the cross section thereof being reversed U-shaped, so that the plate body defines a front lateral plate and a rear lateral plate.

5. The cabinet with lockable drawer structure as claimed in claim 4, wherein a pivoting structure is assembled on the rear side of the drawer and distant from the cabinet body, the pivoting structure at least comprises a positioning plate and a rotating plate connected together, the pivoting structure is connected with the rear side of the drawer via the positioning plate, and the rotating plate is provided to connect with a rear portion of the bottom of the plate body where the rear portion is near to the rear lateral plate, so that the plate body is pivotable with respect to the drawer via the pivoting structure.

6. The cabinet with lockable drawer structure as claimed in claim 5, wherein the pivoting structure further comprises a torsion spring assembled therein, so that the plate body connected with the pivoting structure moves resiliently and automatically via the elastic force of the torsion spring.
